(19) United States
(12) Patent Application Publication
(10) Pub. No.: US 2008/0005034 A1
(43) Pub. Date: Jan. 3, 2008

(54) Method and Apparatus for Efficient Use of Trusted Third Parties for Additional Content-Sharing Security

(75) Inventors: David W. Kravitz, Fairfax, VA (US); Thomas S. Messerges, Schaumburg, IL (US); Paul S. Montague, Highbury (AU); Glen T. Olafsen, Redwood Park (AU); Michael J. Terrington, Highbury (AU)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: GENERAL INSTRUMENT CORPORATION, Horsham, PA (US)

(21) Appl. No.: 11/760,035

(22) Filed: Jun. 8, 2007

Related U.S. Application Data
(60) Provisional application No. 60/812,447, filed on Jun. 9, 2006.

(51) Int. Cl. H04L 9/00

(52) U.S. Cl. 705/59

(57) ABSTRACT

A method is disclosed that receives, at a sink device, encrypted content. Further, the method receives, at the sink device, content license data from a source device. In addition, the method analyzes the content license data to determine whether a rights issuer that generated the content license data intended that the source device, which has cryptographic access to the content license data, be authorized to send, to the sink device, a value that enables decryption of the encrypted content. The method also receives the value and decrypts the encrypted content if the rights issuer intended that the source device be authorized to transfer the value to the sink device.

### RELATED APPLICATIONS

This application claims priority to U.S. Provisional Application Ser. No. 60/812,447 entitled “Efficient Use Of Trusted Third Parties For Additional Content-Sharing Security,” filed on Jun. 9, 2006, the content of which is incorporated herein by reference in its entirety.

### BACKGROUND

1. Field

This disclosure generally relates to the field of security for content sharing. More particularly, the disclosure relates to Digital Rights Management (“DRM”) for content sharing.

2. General Background

Traditionally, using standard DRM procedures, a Rights Issuer (“RI”) generates a content license, e.g., a Rights Object (“RO”), which enables a specified device, or group of devices, to access the associated content. For example, the ciphertext content may be freely available, but an appropriate RO must be acquired in order to recover the usable plaintext content from the ciphertext content. These ROs are cryptographically bound to the devices or group of devices. As a result, the content is tightly controlled. However, this approach is limiting because of the direct RI involvement that is required to either acquire a device specific RO or be added to the membership of a domain of devices to be able to acquire or usefully access a domain RO. The domain of devices is a group of devices that can each access the content through the domain RO.

Accordingly, the traditional approach does not provide an adequate way for the secure sharing of content between the devices themselves, e.g., in a peer-to-peer configuration. For instance, one device may act as a source device to provide content to a sink device. The terms “source device” and “sink device” are situational terms for a particular transaction as a device may be a source device in one transaction yet a sink device in a different transaction. Further, the source device may not have been the original recipient of the content it is providing to the sink device, i.e., the source device may have acted as a sink device to previously receive the content from another source device.

One approach involves a source device (1) creating ROs for the purpose of sharing with sink devices and (2) creating ROs for local tracking so that the source and sink devices may utilize the ROs they hold for the purpose of periodically reporting back activity to the RI. This approach does not provide for independent content integrity or prevent fabrication by rogue source devices.

Another approach involves use of a DRM content server, users' personal content servers, and specific terminals. The specific terminals may be utilized by the users to buy DRM content for their personal content servers rather than for an individual one of their terminals so that their personal content server can then re-distribute the DRM content to the user's terminals. This approach does not ensure validity checking in a secure manner.

The current approaches are ineffective in preventing piracy for sharing of content between devices. Such piracy may involve use of a rogue source device to break sharing rules and/or inject pirated content such that the pirate's customers may receive content less expensively than if they acquired it legitimately. Further, the pirate normally protects his or her investment in that the plaintext content and cryptographic keys are protected by the compliant sink device. This would not be the case if the pirate published the plaintext content and/or keys over the Internet.

### SUMMARY

In one aspect of the disclosure, a method is disclosed. The method receives, at a sink device, encrypted content. Further, the method receives, at the sink device, content license data from a source device. In addition, the method analyzes the content license data to determine whether a rights issuer that generated the content license data intended that the source device, which has cryptographic access to the content license data, be authorized to send, to the sink device, a value that enables decryption of the encrypted content. The method also receives the value and decrypts the encrypted content if the rights issuer intended that the source device be authorized to transfer the value to the sink device.

In another aspect of the disclosure, a method is disclosed. The method receives, at a first device, content license data associated with encrypted content. The content license data includes an indication as to whether a rights issuer intended that the first device, which has cryptographic access to the content license data, be authorized to send, to a second device, a value that enables decryption of the encrypted content. Further, the method sends, from the first device, the content license data to the second device. In addition, the method sends, from the first device, the value to the second device if the rights issuer intended that the first device is authorized to send the value to the second device.

In yet another aspect of the disclosure, a method is disclosed. The method composes a content license for encrypted content. The content license indicates one or more devices intended to utilize the encrypted content. Further, the method sends, to a device, content license data and a value enabling decryption of the encrypted content. The content license data includes at least a portion of the content license and identifies one or more additional devices that are intended to receive the value.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a configuration that extends the partial usability of a content license.

FIG. 2 illustrates a configuration that sends the CEK from a source device to a sink device in addition to extending the partial usability of the content license.

FIG. 3 illustrates a configuration that implements reporting in addition to sending the CEK from the source device to the sink device and extending the partial usability of the content license.

FIG. 4 illustrates a sharing with reporting protocol.

FIG. 5 illustrates a sharing with pairing protocol.

FIG. 6 illustrates a process that may be utilized by a device acting as a sink device.

FIG. 7 illustrates a process that may be utilized by a device acting as a sink device and then as a source device.

FIG. 8 illustrates a process that may be utilized by an RI.

FIG. 9 illustrates a block diagram of a station or system that implements content sharing.

### DETAILED DESCRIPTION

A method and apparatus are disclosed, which enable secure content sharing between devices. In one embodiment, partial usability of a content license may be extended to devices. Further, in another embodiment, a content encryption key (“CEK”) may be shared between the devices. In addition, in another embodiment, a reporting configuration may be utilized.

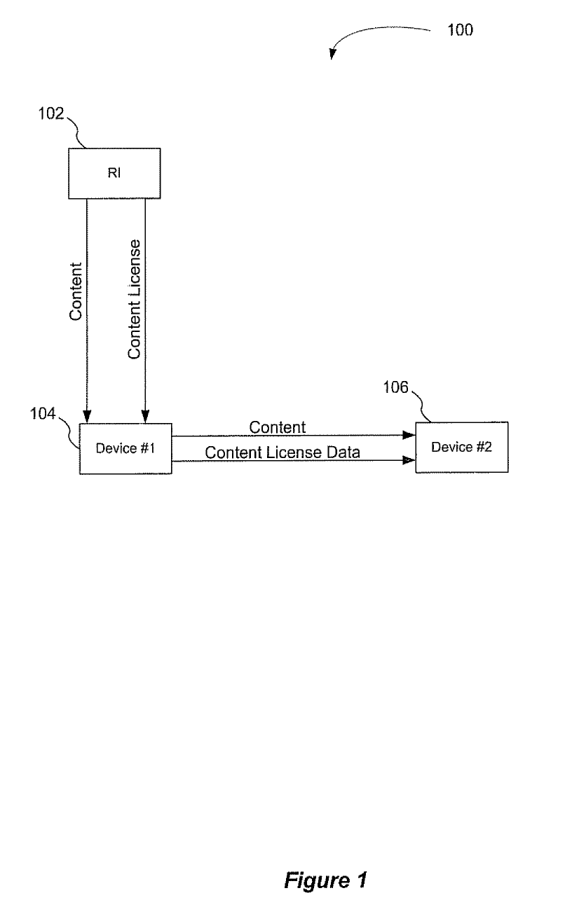

FIG. 1 illustrates a configuration 100 that extends the partial usability of a content license. An RI 102 initially sends content and corresponding content license data to a first device 104 acting as a sink device. In one embodiment, the content is encrypted. Further, in an alternative embodiment, the first device 104 may receive the content license data from the RI 102, but may receive the encrypted content from elsewhere. The content license data may include information such as rights for particular content. In other words, the content license data includes all or part of a content license that is generated by an RI for direct access by a particular device or by a plurality of devices that have knowledge of a particular domain key. The first device 102 then attempts to share the content with the second device 106. Accordingly, the first device 102, which now acts as a source device, sends the content and the corresponding content license data to the second device 106, which acts as the sink device.

The configuration 100 maintains the verifiability of the content license. For example, the configuration 100 may maintain the integrity of the content, content license ID, and sharing constraints. Further, the content license may identify acceptable trusted third parties (“TTPs”), which do not need to be certified as RIs. Content licenses generated by distinct RIs may point to the same TTP. By extending the partial usability of the content license, the configuration 100 prevents a Content Encryption Key (“CEK”), which may be utilized to decrypt the content, from being extracted from the content license unless one or more conditions are met. In one embodiment, the condition may be that the content license was originally targeted by the RI 102 for the second device 106. Accordingly, the forwarding of the content license by the first device 104 to the second device 106 is permissible. In an alternative embodiment, the RI 102 may omit specification of the device id of a second device, thus allowing flexibility in choice of second and possibly subsequent devices during sharing in accordance with sharing constraints, if any. In one embodiment, the RI 102 is a TTP relative to the source device and the sink device.

The processing of the content license may proceed through one or more stages. For instance, the RI 102 may digitally sign one or more portions of the content license data with an RI digital signature. Further, the RI digital signature may be verified by the second device 106 at the outset to ensure the integrity of the associated ciphertext content, i.e., that the encrypted content has not been tampered with during transmission or by the first device 104. A hash of the ciphertext content may be included in the content license data to enable integrity checking. The hash is considered data associated with the encrypted content. Verification of the validity of the plaintext content, i.e., the result of decrypting the encrypted content, may require knowledge of the associated CEK.

While the content license may identify one or more TTPs, an alternative embodiment allows one or more sharing constraints and/or one or more TTP identifier aspects to be provided for through other mechanisms, such as messaging external to the actual content licenses, or within device code. A TTP may be certified within a certificate chain under a root public key held securely by the devices.

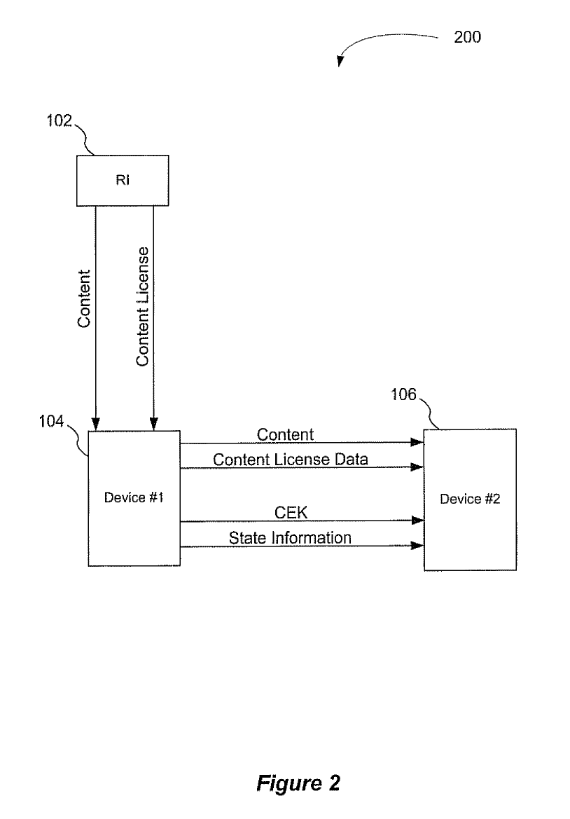

FIG. 2 illustrates a configuration 200 that sends the CEK from a source device to a sink device in addition to extending the partial usability of the content license. The second device 106, acting as the sink device, receives the CEK from the first device 104, acting as the source device, not from the content license. The RI 102 exercises its options with regard to which sharing constraints to include in the content license. The content license may include sharing constraints that may indicate, in particular, TTP-enabled device pairing requirements in order for the sink device to utilize the CEK. For example, the sharing constraints for the source-sink pairing may provide that a source-sink pairing is required for each content item, each session, a certain time interval, and/or a certain content amount. The source device may also pass along applicable state information. For example, the source device may have previously inherited twelve plays, and the RI-issued content license may have indicated a twenty-five play limit. The source device may choose to provide the sink device with five plays of the content. The sink device can independently verify the original twenty-five play limit but not that the five plays legitimately remain. Unlike the previous approaches, the configuration 200 provides the ability to forward content license data generated by the RI 102, for use in independent content integrity and verifiability by sink devices.

While the content license data and CEK may be sent from a source device to a sink device as discussed above, alternative configurations may be utilized to transmit the actual data in the form of content license data and other information, including a secret value capable of providing cryptographic access, that together enable derivation of the CEK and verification of the digital signature. However, in another alternative configuration, the authenticity of the CEK does not need to be verified because a strong encryption algorithm may be deployed. The strong encryption algorithm prevents the legitimate ciphertext content from yielding non-legitimate, but meaningful, plaintext content via substitution of the CEK value. In this alternative configuration, the CEK value itself is securely transmitted from the source device to the sink device. The CEK does not disclose sensitive information about other content objects irrespective of whether the original content license was a device content license or a domain content license. This is because knowledge of a CEK does not reveal any knowledge of the domain key that is utilized during the generation of a domain content license by an RI and each instance of content object plaintext may be encrypted using an independently derived CEK value.

The value may be utilized with other information to derive the CEK or may actually be the CEK itself. For example, the original content license, as issued by the RI 102 may contain a cryptographic key that is accessible only via knowledge of a device private key or a domain key as the cryptographic key is in the original content license in encrypted form based on use by the RI 102 of a device public key or domain key. The cryptographic key may be a CEK or a key-encrypting key. If the cryptographic key is a key-encrypting key, then the cryptographic key may be applied to a portion of the original content license to recover the CEK in order to decrypt the encrypted content. In one configuration, multiple assets are associated with a single content license. Accordingly, multiple CEKs may exist. If the cryptographic key is a key-encrypting key, then the content license may be constructed so that the same value of the cryptographic key may be utilized to recover the CEKs corresponding to the multiple assets. If the cryptographic key is a key-encrypting key, then a source device may transfer to the sink device information, i.e., value(s), that may be used to recover the cryptographic key from data in the original content license. Alternatively, the source device may transfer the cryptographic key or the CEK(s) directly. A Secure Authenticated Channel may be utilized for any of these transfers. If the cryptographic key is a key-encrypting key and the source device transfers the CEK(s) directly, then the sink device does not need to utilize data within the original content license in order to decrypt the encrypted content. If the cryptographic key is a CEK, then the device to which the original content license is cryptographically bound by the RI 102, or a domain member device within the domain to which the original content license is cryptographically bound by the RI 102 must still access the original content license in order to recover the cryptographic key. When a source device transfers the cryptographic key, i.e., CEK(s), to a sink device, the sink device will not have to access data within the original content license in order to decrypt the encrypted content. In one embodiment, a first device may have gained cryptographic access to the content license data by utilizing a received value at the first device. The received value is not necessarily identical to the value that the first device is authorized to send to the second device.

In one embodiment, the content is encrypted. Further, in an alternative embodiment, the first device 104 may receive the content license data from the RI 102, but may receive the encrypted content from elsewhere. In yet another alternative embodiment, the second device 106 may receive the content license data from the first device 104, but may receive the encrypted content from elsewhere.

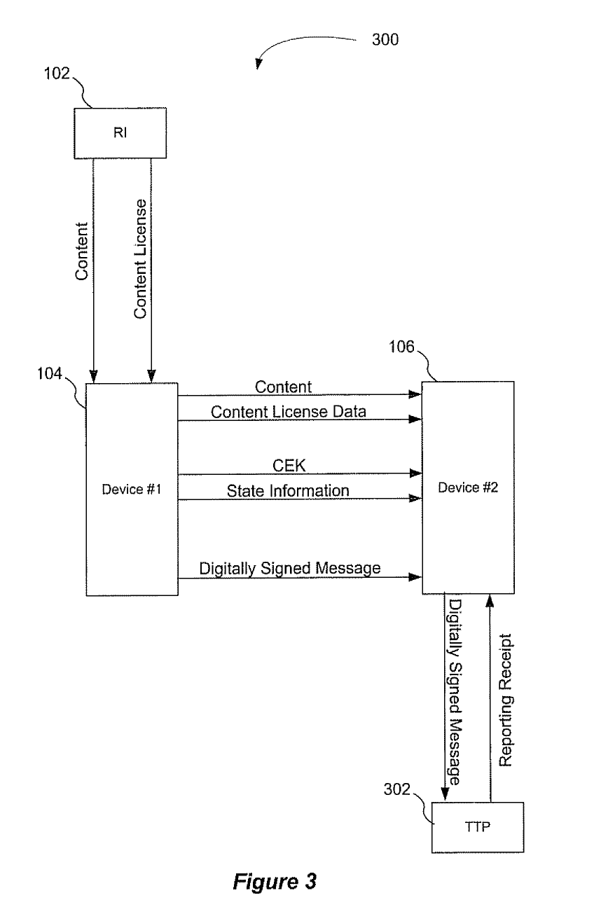

FIG. 3 illustrates a configuration 300 that implements reporting in addition to sending the CEK from the source device to the sink device and extending the partial usability of the content license. The first device 104, acting as a source device, digitally signs a message that indicates sharing information. For example, the sharing information may include the source and sink device IDs, content ID, content license ID, time of day, nonce, number of copies shared, etc. The second device 106, acting as the sink device, verifies this message and securely reports back the sharing data and the digitally signed message to a TTP 302. The content license identifies acceptable TTPs 302 to which the second device 106, acting as the sink device may report. The TTP 302 then sends a reporting receipt back to the second device 106 to indicate that the TTP received the message from the second device 106. Activity is automatically restricted for a compliant sink device that does not receive reporting receipt from the TTP 302. Reporting back to the TTP 302 can be performed in bulk by aggregating previously unreported content sharing transactions. The process of analyzing reports and/or failure of devices to report in timely fashion can result in device revocation.

The digital signature of the message by the first device 104 mitigates against the second device 106, acting as a sink device, framing the first device 104. As an example of framing, the second device 106 may receive access to content from a source device other than the first device 104 and report to a TTP 302 that the second device 106 received the access to content from the first device 104, which may not be allowed by the content license. The first device 104 would potentially have its privileges revoked as a result of the framing. As another example, the first device 104 may receive ten copies of content and provide the second device 106 with five copies of the content. The second device 106 may then send six copies of the content to an additional device and state that the first device 106 provided six copies. Accordingly, the first device 104 normally has to report to a TTP the copies that it sends to the second device 106 to avoid being framed by the second device 106. The configuration 300 prevents this type of framing of the source device and eliminates the need for the source device to report back to the TTP. Unlike the previous approaches, the configuration 300 provides for reporting by sink devices based on the content license IDs, which cannot be fabricated by rogue source devices. The configuration 300 does not rely on validity checking of a specific terminal, which is utilized by a user to purchase DRM content for a personal content server, to be solely handled by the personal content server without requiring third party terminal-specific authorization or reporting back to a third party.

The role of the TTP 302 is effectively minimized by utilizing the configuration 300. While a TTP 302 reduces the need of direct RI involvement during sharing, the TTP 302 should still only have access to information that is needed for the TTP 302 to operate effectively. In other words, the configuration 300 enhances security by reducing the transmission of sensitive information even to trusted entities. Accordingly, the TTP 302 should not have or be given access to sensitive information, such as the CEK, that is not needed for the TTP 302 to operate effectively. The TTP 302 may even have limited enough involvement to allow for offline sharing by the first device 104 and the sink device 106. Further, the TTP 302 should not be able to frame compliant devices or innocent users.

In one embodiment, the content is encrypted. Further, in an alternative embodiment, the first device 104 may receive the content license data from the RI 102, but may receive the encrypted content from elsewhere. In yet another alternative embodiment, the second device 106 may receive the content license data from the first device 104, but may receive the encrypted content from elsewhere.

The configurations described in FIGS. 1-3 effectively detect illicit activity by source devices that sink devices, acting independently, would not be able to detect. Further, these configurations detect abuse and ultimately prevent pirates from utilizing a rogue source device to distribute content to compliant sink devices, where the compliant sink devices are not necessarily being utilized by honest consumers.

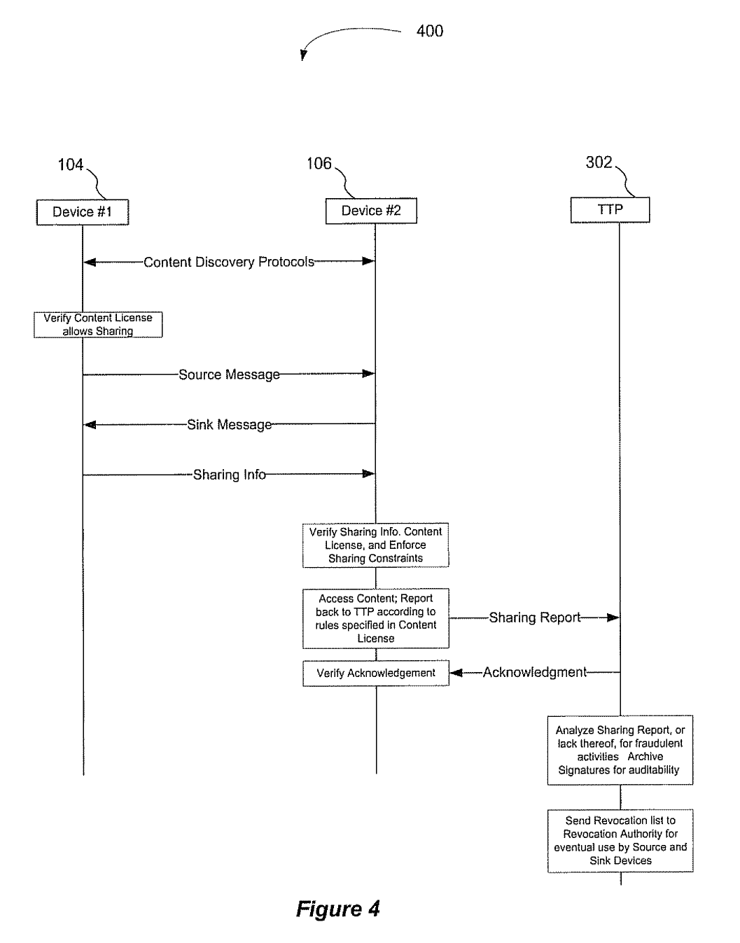

FIG. 4 illustrates a sharing with reporting protocol 400. The sharing protocol 400 allows for sharing with reporting. At the outset, the first device 104, acting as the source device, and the second device 106, execute one or more content discovery protocols. The content discovery protocols allow one device to determine if another device has the ability to transfer rights to content. In one embodiment, the device with the rights may transfer the content and the rights associated with the content to the receiving device. In another embodiment, the device with the rights may transfer the rights associated with the content alone to a receiving device that obtains the content from elsewhere. Accordingly, if the second device 106, acting as the sink device, requests particular content, the first device 104, acting as the source device, verifies that the content license for the content stored on the first device 104 allows for sharing of that content. The first device 104 may have received the content and content license from the RI 102 (shown in FIGS. 1-3) or from another device that acted as a source device while the first device 104 acted as a sink device. If the content license allows for sharing, the first device 104 sends a source message to the second device 106. An example of the source message is the following message:
“Source hello”: ID_source, nonce_source, certificate chain of source, protocol/algorithm options

Further, the second device 106 sends a sink message to the first device 104. An example of the sink message is the following message:

“Sink hello”: M_1 = {ID_sink, ID_source, nonce_sink,
nonce_source, request, protocol/algorithm selections},
signature_sink(M_1), certificate chain of sink

The signature_sink(M_1) is the sink device's signature of M_1, and the request is a text container for a specific request from the sink device, e.g., to obtain content license data with respect to specific content license ids, a number of plays, or an amount of time with respect to content usage. In addition, the first device 104 sends sharing information to the second device 106. The sharing information includes the content and the content license. An example of the message including the sharing information is the following:

| | |
|---|---|
| “Sharing info”: | M_2 = {ID_sink, ID_source, nonce_sink, |

| | | |
|---|---|---|
| nonce_source, | Enc_PK_sink | (pre_master_secret), |

Enc_K_session(CEK ∥ content license ∥ applicable state
info), time of day, etc.}, signature_source(M_2)

Enc_PK_sink (pre_master_secret) represents the pre_master_secret encrypted with the sink device's public key, Enc_K_session(CEK∥content license∥applicable state info) represents (CEK∥content license∥applicable state info) encrypted with K_session, which is a session key derived from pre_master_secret, nonce_source, and nonce_sink. ∥ denotes concatenation. Further, signature_source(M_2) is the sink device's signature of M_2. In this embodiment, the sharing information includes information that may be utilized to decrypt the CEK. For instance, the sharing information includes a pre_master_secret, nonce_source, and nonce_sink that may be utilized to derive the K_session and then use it decrypt CEK. The CEK allows the second device 106 to decrypt the content.

The second device 106 communicates with the TTP 302 utilizing a secure authenticated channel to ensure protection of privacy, authenticity, integrity, and freshness. The second device 106 verifies the sharing information, content license, and enforces the sharing constraints. Further, the second device 106 then accesses the content by decrypting the encrypted content with the CEK and prepares a sharing report according to the rules specified in the content license. The sharing report may be utilized in device revocation decisions. The second device 106 then sends the sharing report to the TTP 302. After receiving the sharing report, the TTP 302 sends an acknowledgement to the second device 106. The second device 106 then verifies the acknowledgement.

The TTP 302 analyzes the sharing report to determine if any fraudulent activities are present. Further, if no sharing report is received from the second device 106, the TTP 302 may attempt to determine if any fraudulent activities are present. The TTP 302 also archives signatures for auditability. If the TTP 302 determines that fraudulent activity exists, the TTP 302 may add the first device 104 and/or the second device 106 to a revocation list. Further, the TTP 302 may send the revocation list to a Revocation Authority, which may then forward the list to source and sink devices for future use.

The sharing with reporting protocol 400, up to the point of the second device reporting back to the TTP 302, may be performed when the second device 106, acting as the sink device, is offline. In other words, the second device 106 need not necessarily be connected to the TTP 302 until the actual reporting is required.

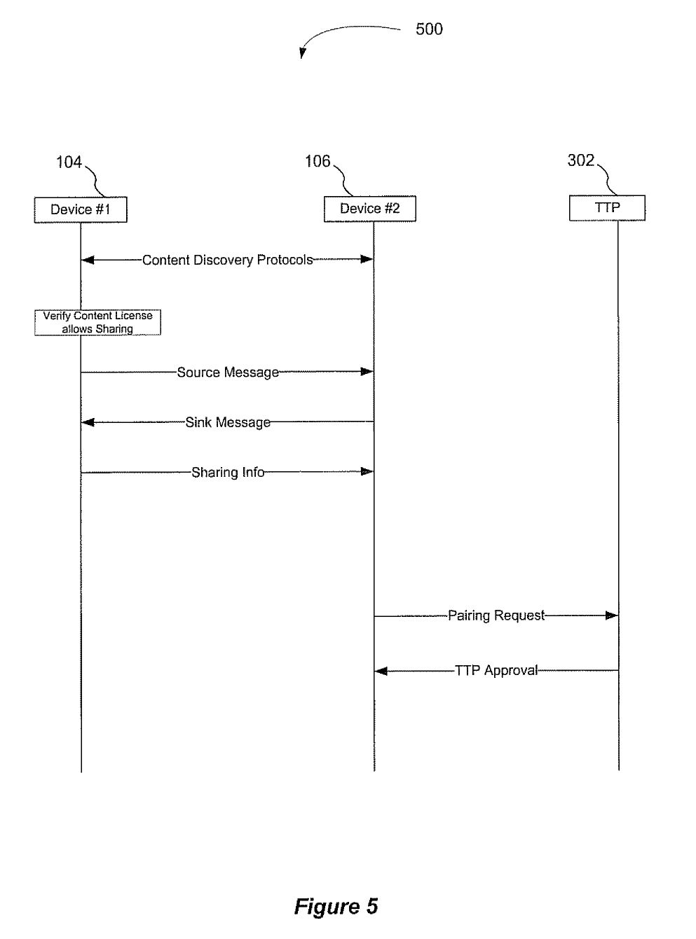

FIG. 5 illustrates a sharing with pairing protocol 500. At the outset, similar to the sharing with reporting protocol 400, the sharing with pairing protocol 500 has the first device 104, acting as the source device, and the second device 106, exchange one or more content discovery protocols. Further, similar to the sharing with reporting protocol 400, if the second device 106, acting as the sink device, requests particular content, the first device 104, acting as the source device, verifies that the content license for the first device 104 allows for sharing of content corresponding to the content license. If the content license allows for sharing, the first device 104 sends a source message to the second device 106. Further, the second device 106 sends a sink message to the first device 104. In addition, the first device 104 sends sharing information to the second device 106. The sharing information includes the content and the content license. An example of the message including the sharing information is the following:

“Sharing info”: M_2 = {ID_sink, ID_source, nonce_sink,
nonce_source, Enc_PK_sink(pre_master_secret),
Enc_PK_TTP(K_rand), Enc_K_session(Enc_K_rand(CEK)
∥ content license ∥ applicable state info), time of day, etc.},
signature_source(M_2)

Enc_PK_sink (pre_master_secret) represents the pre_master_secret encrypted with the sink device's public key. Further, Enc_PK_TTP(K_rand) represents K_rand, i.e., a random value chosen by the source device, encrypted with the public key of the TTP 302. In addition, Enc_K_session(Enc_K_rand(CEK)∥content license∥applicable state info) represents (Enc_K_rand(CEK)∥content license∥applicable state info) encrypted with K_session, which is a session key derived from pre_master_secret, nonce_source, and nonce_sink. Enc_K_rand(CEK) represents CEK encrypted with K_rand. In contrast to the sharing with reporting protocol 400, in the sharing with pairing protocol 500, the second device 106, acting as the sink device, cannot, independently from the TTP 302, gain access to the CEK. For example, in message M_2 of the sharing with pairing protocol 500, the CEK is encrypted with a masking value K_rand, and K_rand is encrypted with the public key of the TTP. Only the TTP 302 should have the private key needed to extract K_Rand. Thus, the CEK value is unavailable to the second device 106 until the TTP 302 releases the masking value. Also, since the CEK is encrypted with both K_rand and K_session, neither the second device 106 nor the TTP 302 alone can decrypt CEK by simply having access to M_2.

An example of a Pairing Request message sent to the TTP 302 is as follows:

“Pairing Request: M_3 = {ID_source, ID_sink, ID_TTP,
Enc_PK_TTP(K_rand), ID_license}, signature_sink(M_3) ,
certificates if necessary

Enc_PK_TTP(K_rand) represents K_rand encrypted with the public key of the TTP 302.

As a pre-requisite to response by the TTP 302 that enables pairing, the TTP 302 can check current revocation status. Further, the TTP 302 sends an approval if the devices do not appear on a revocation list. An example of a message sent from the TTP 302 is as follows:

“TTP approval”: M_4 = {{ID_source, ID_sink, ID_TTP,
Enc_PK_sink(K_rand)}, signature_TTP(M_4) , certificates if
necessary

Enc_PK_sink(K_rand) represents K_rand encrypted with the public key of the second device 106.

These communications are made utilizing adequate security measures, such as encryption for privacy protection. Actual connectivity to the TTP 302 may be via the source or sink device.

The sharing protocols discussed above allow for mutual authentication. As a result, no sensitive information is delivered to unintended devices by compliant source devices. Access-enabling data cannot be successfully utilized by a compliant sink device if not freshly authorized by a specific designated source that originated initial delivery. In other words, the source device's knowledge of confidential data, e.g., CEK, needs to be made available to a target sink device for that sink device to successfully utilize the access-enabling data.

As a result of the sharing with pairing protocol 500, which may be online, the source and sink devices are aware of joint source and sink approval by the TTP 302. Accordingly, if the pairing is considered currently valid relative to a later content license, the sharing with reporting protocol 400, which may be offline, may be utilized. The actual reporting by the sink accessing such a content license in the sharing with reporting protocol 400 may be optional. Further, some of the code utilized by the sharing with reporting protocol 400 is similar to some of the code utilized by the sharing with pairing protocol 500, which allows for reuse efficiency. In addition, the sharing protocols allow several content licenses and CEKs to be utilized simultaneously.

The sharing protocols allow a compliant device to report back sharing activities for which it was a sink device to the TTP 302. Additionally, the sink device may verify the integrity of the original plaintext content and content license. In other words, the sink device may utilize the CEK and the public key of the RI 102 to verify that the sink device is not being given permissions by the source device that are not within the permissions of the original content license or access to unintended content.

In one embodiment, framing attacks may be mitigated by having a device sign those elements for which it acts as source device so that the corresponding sink device can incorporate these signatures into its cumulative report to the TTP 302. The signatures applied by source devices mitigate potential for users of rogue sink devices to collude to frame a source device. Only rogue sink devices can alter, but still not fabricate, elements of their reports. Further, the TTP 302 may authenticate that the sharing report has not been modified in transit. The sharing report may also be encrypted for privacy against eavesdropping.

In another embodiment, the source devices as well as the sink devices report to the TTP 302. For instance, if many devices report sharing content to the same sink device and all of that content is later released in plaintext form over the Internet, then there would be circumstantial evidence that the particular device may have been compromised.

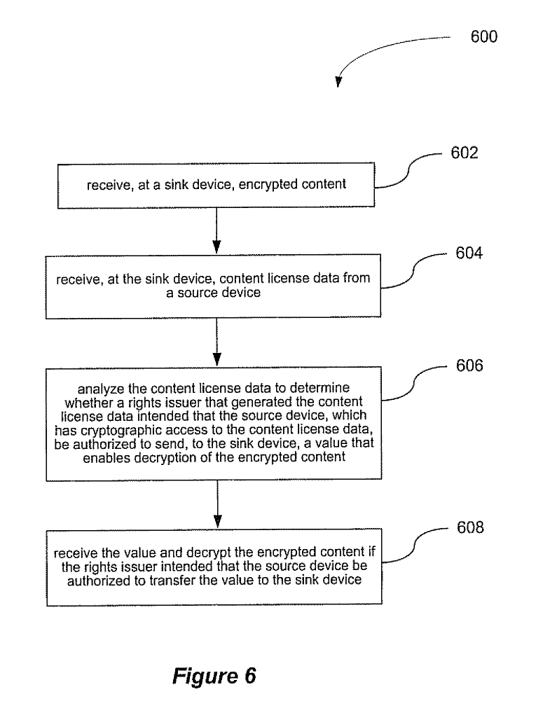

FIG. 6 illustrates a process 600 that may be utilized by a device acting as a sink device. At a process block 602, the process 600 receives, at a sink device, encrypted content. Further, at a process block 604, the process 600 receives, at the sink device, content license data from a source device. In addition, at a process block 606, the process 600 analyzes the content license data to determine whether a rights issuer that generated the content license data intended that the source device, which has cryptographic access to the content license data, be authorized to send, to the sink device, a value that enables decryption of the encrypted content. Finally, at a process block 608, the process 600 receives the value and decrypts the encrypted content if the rights issuer intended that the source device be authorized to transfer the value to the sink device.

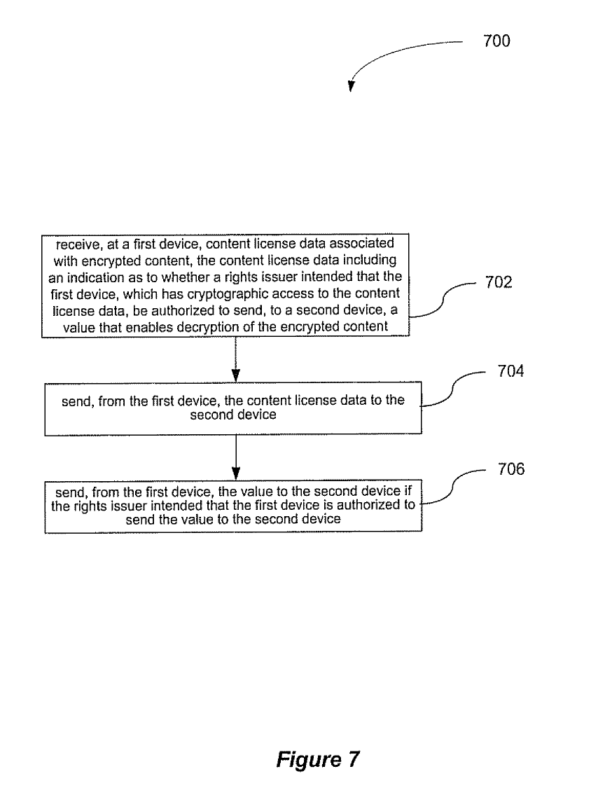

FIG. 7 illustrates a process 700 that may be utilized by a device acting as a sink device and then as a source device. At a process block 702, the process 700 receives, at a first device, content license data associated with encrypted content. The content license data includes an indication as to whether a rights issuer intended that the first device, which has cryptographic access to the content license data, be authorized to send, to a second device, a value that enables decryption of the encrypted content. Further, at a process block 704, the process 700 sends, from the first device, the content license data to the second device. Finally, at a process block 706, the process 700 sends, from the first device, the value to the second device if the rights issuer intended that the first device is authorized to send the value to the second device.

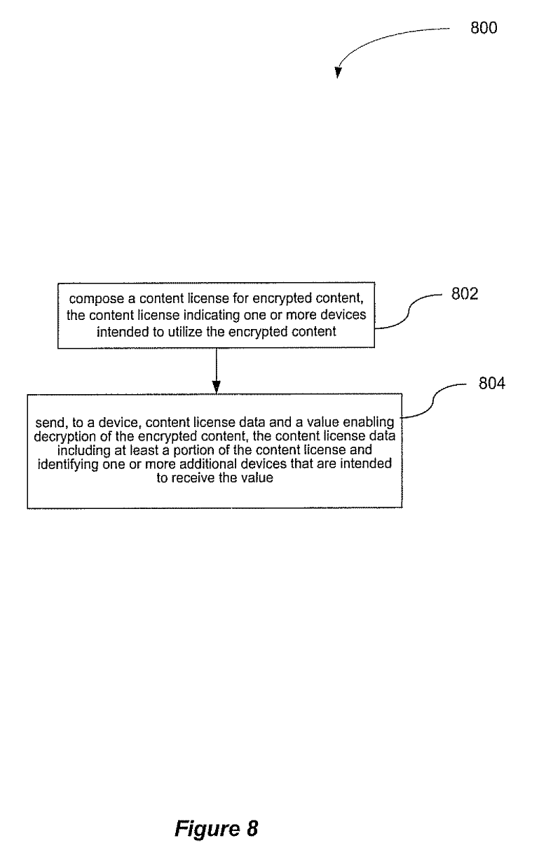

FIG. 8 illustrates a process 800 that may be utilized by an RI 102. At a process block 802, the process 800 composes a content license for encrypted content. The content license indicates one or more devices intended to utilize the encrypted content. Further, at a process block 804, the process 800 sends, to a device, content license data and a value enabling decryption of the encrypted content. The content license data includes at least a portion of the content license and identifies one or more additional devices that are intended to receive the value. The one or more additional devices may be identified by a condition. An example condition is that the sink device be a specific device or a member of a specific class of devices. Conditions may be expressed in the form of sharing constraints.

In one embodiment, dual sourcing is provided. In other words, a sink device may perform two verifications: (1) the initial state information, e.g., an initial allowance of n plays, and sharing constraints, and possibly also encrypted content, may be verified as having originated from the RI 102; and (2) more recent state information, e.g., move m of the n plays allowed in the original content license to the sink device, where the source device earlier acted as a sink device when receiving the encrypted content, may be verified as having come from the source device. The data coming from the source device may be verified by the sink device for conformance with the initial state information by ensuring, for example, that m does not exceed n. For instance, the source device may deliver the content license, the CEK, and state information to the sink device. The sink device may then authenticate that the content license was originated by RI 102. The sink device also may authenticate the CEK and all associated data as coming from the particular source device.

As a result, the sink device may perform independent verification of content authenticity and content integrity without additional involvement from the RI 102. The content license ID and sharing constraints not being able to be spoofed by a rogue source device enables effective communication to a TTP 302, which does not need RI-level access. Such effective communication may include cumulative reporting by a device of its previous sink-based activity since its last acknowledged report. Such effective communication may additionally or alternatively include, as part of pairing requests, an indication of sharing request parameters.

Further, the utilization of the sharing protocols may result in denial of pairings and/or later detection of anomalous source-based and/or sink-based behavior leading to device revocation. Sink devices that do not effectively report back as required may be detected by the TTP 302 as device non-compliant and/or user-non-compliant. Compliant devices that do not receive TTP-generated receipts, i.e., sharing report acknowledgements, may be programmed to automatically restrict their activity. The automatic restriction addresses the scenario in which a user of the sink device may try to block, e.g., by interfering with the transmission medium to the TTP 302, the transmission of reports indicating fraudulent activities by one or more devices to the TTP 302. As a result, pirates are unable to undetectably utilize rogue source devices to distribute access to content to compliant sink devices.

Accordingly, illicit activity that sink devices acting independently could not previously detect may now be detected. An example of such illicit activity is a violation of stateful constraints, e.g., distribution of cumulatively excessive number of accessible copies or authorization of plays which cumulatively exceed constraint within the original content license. Another example of such illicit activity is a violation of stateless rights, where, e.g., rather than removing from the source device cryptographic access to the content license following successful transmission to the sink device of data that transfers cryptographic access to the content license, the source device retains access so that it can grant access to additional sink devices. Reports sent to the TTP 302 may be aggregated and examined for fraudulent activity.

Certain applications may allow a resource-constrained device, e.g., a smart card, to be involved in passing access to content from one device to another. The resource-constrained device does not itself consume the content. Further, the resource-constrained device's participation first as a sink and later as a source may be separated in time. The resource-constrained device may pass along information, which is verifiably attributable to the device that sourced the content license to it, to the sink device to which it later acts as source. The sink device may then report these indirect transactions during upload to the TTP 302. In this scenario, the resource-constrained device need not self-report, but would engage in the sharing protocol with the sink device, whereby the sink device would be reporting on an embedded sharing transaction: For example, [M_2, signature_source(M_2)] coming from the source device relative to the resource-constrained device as sink device could be incorporated into the M_2 value generated by the resource-constrained device when it later acts as the source device.

Such resource-constrained devices can effectively be made less constrained, by using devices as conduits to a TTP 302, while not having to rely on these devices for their own security. This helps to control the spread of compromises. In one embodiment, a smart card that does not have its own reliable clocking mechanism can measure elapsed time between events by contacting a secure time server TTP such as an Online Certificate Status Protocol (“OCSP”) responder through a device that requests current time from an OCSP and returns the OCSP's response to the smart card. Any “conduit” device would suffice for this purpose, and does not need to be part of the DRM system as long as it is able to communicate effectively with an OCSP or other time server trusted by the smart card. The smart card does not trust the conduit device to ensure the freshness of the OCSP responses. If nonces are used for this purpose, the smart card must provide the nonces to the conduit device for use by the OCSP in its responses. As an example scenario where there may be utilization of this relay mechanism, the smart card is supposed to wait at least one hour between initiating event A and initiating event B. Event A and event B involve sharing of the same content. At the onset of event A, the smart card sends an OCSP request via a device it happens to be connected to and receives that verifiable response. The smart card later submits another OCSP request, which is potentially via another device and/or another OCSP responder. The amount of time that has elapsed between requests by the smart card is at least as long as the difference in times marked within the OCSP responses, since a response corresponding to a request that predates the request initiated by the smart card will be rejected because the smart card generates its nonces unpredictably.

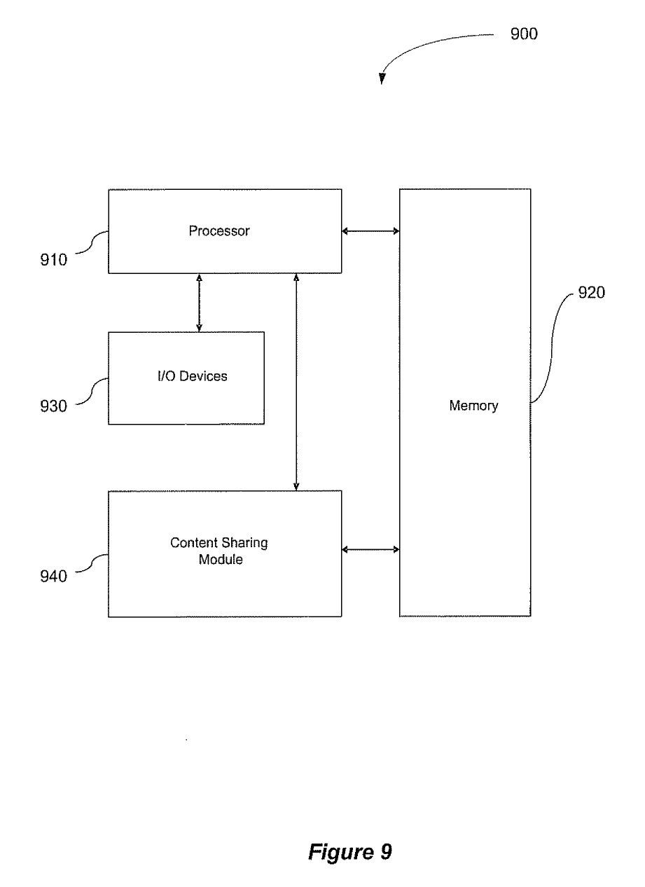

FIG. 9 illustrates a block diagram of a station or system 900 that implements content sharing. In one embodiment, the station or system 900 is implemented using a general purpose computer or any other hardware equivalents. Thus, the station or system 900 comprises a processor 910, a memory 920, e.g., random access memory (“RAM”) and/or read only memory (ROM), a content sharing module 940, and various input/output devices 930, (e.g., storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)).

It should be understood that content sharing module 940 may be implemented as one or more physical devices that are coupled to the processor 910 through a communication channel. Alternatively, the content sharing module 940 may be represented by one or more software applications (or even a combination of software and hardware, e.g., using application specific integrated circuits (ASIC)), where the software is loaded from a storage medium, (e.g., a magnetic or optical drive or diskette) and operated by the processor in the memory 920 of the computer. As such, the content sharing module 940 (including associated data structures) of the present disclosure may be stored on a computer readable medium, e.g., RAM memory, magnetic or optical drive or diskette and the like.

It is understood that the content sharing described herein may also be applied in other types of systems. Those skilled in the art will appreciate that the various adaptations and modifications of the embodiments of this method and apparatus may be configured without departing from the scope and spirit of the present method and system. Therefore, it is to be understood that, within the scope of the appended claims, the present method and apparatus may be practiced other than as specifically described herein.

We claim:

1. A method comprising:
receiving, at a sink device, encrypted content;
receiving, at the sink device, content license data from a source device;
analyzing the content license data to determine whether a rights issuer that generated the content license data intended that the source device, which has cryptographic access to the content license data, be authorized to send, to the sink device, a value that enables decryption of the encrypted content; and
receiving the value and decrypting the encrypted content if the rights issuer intended that the source device be authorized to transfer the value to the sink device.

2. The method of claim 1, further comprising receiving a rights issuer digital signature over data associated with the encrypted content and authenticating the encrypted content by verifying the rights issuer digital signature.

3. The method of claim 1, further comprising receiving, at the sink device, the value through a secure communication from the source device.

4. The method of claim 3, further comprising calculating a content encryption key from the value and information in the content license data, and decrypting the encrypted content with the content encryption key.

5. The method of claim 1, wherein the value is a content encryption key that is utilized for the decrypting the encrypted content.

6. The method of claim 1, further comprising receiving, at the sink device, state information.

7. The method of claim 1, wherein the content license identifies a trusted third party.

8. The method of claim 1, wherein the content license includes one or more sharing constraints on the encrypted content.

9. The method of claim 1, further comprising sending, from the sink device to a trusted third party, a sharing report that includes one or more messages digitally signed by the source device.

10. The method of claim 1, further comprising receiving, from a trusted third party, authorization to pair the source device and the sink device prior to the decrypting the encrypted content.

11. The method of claim 10, wherein the authorization is determined by a review of revocation status data by the trusted third party.

12. A method comprising:
receiving, at a first device, content license data associated with encrypted content, the content license data including an indication as to whether a rights issuer intended that the first device, which has cryptographic access to the content license data, be authorized to send, to a second device, a value that enables decryption of the encrypted content;
sending, from the first device, the content license data to the second device; and
sending, from the first device, the value to the second device if the rights issuer intended that the first device is authorized to send the value to the second device.

13. The method of claim 12, wherein the indication is a digital signature generated by the rights issuer.

14. The method of claim 12, wherein a calculation of the value and information in the content license data generates a content encryption key that decrypts the encrypted content.

15. The method of claim 12, wherein the value is a content encryption key that decrypts the encrypted content.

16. The method of claim 12, wherein the content license data identifies a trusted third party.

17. The method of claim 12, further comprising sending, from the first device, a sharing report to a trusted third party.

18. A method comprising:
composing a content license for encrypted content, the content license indicating one or more devices intended to utilize the encrypted content; and
sending, to a device, content license data and a value enabling decryption of the encrypted content, the content license data including at least a portion of the content license and identifying one or more additional devices that are intended to receive the value.

19. The method of claim 18, further comprising digitally signing data associated with the encrypted content.

20. The method of claim 18, wherein the content license includes a trusted third party identifier.
